(19) United States
(12) Patent Application Publication
(10) Pub. No.: US 2024/0312373 A1
(43) Pub. Date: Sep. 19, 2024

(54) SIGN APPARATUS

(71) Applicant: Belinda Boyd, Conway, AR (US)

(72) Inventor: Belinda Boyd, Conway, AR (US)

(21) Appl. No.: 18/122,448

(22) Filed: Mar. 16, 2023

(51) Int. Cl. G09F 7/02

(52) U.S. Cl. CPC G09F 7/02

(57) ABSTRACT

A sign apparatus for interchangeably displaying indicia on a plank via removable covers, eliminating the need for multiple signs includes the plank. A cover is removably positioned around and secured to the plank such that a front side of the cover faces outwardly away from the plank. The cover is flexible such that the cover conforms to a shape of the plank, and indicia is positioned on the front side of the cover.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to sign apparatuses and more particularly pertains to a new sign apparatus for interchangeably displaying indicia on a plank via removable covers, eliminating the need for multiple signs.

### (2) Description of Related Art including information disclosed under 37 CFR 1.97 and 1.98.

The prior art relates to sign apparatuses which display indicia on a cover. U.S. Pat. No. 6,341,713 discloses a waste container and cover assembly for covering a waste container with a decorative cover. U.S. Pat. No. 7,261,233 discloses a decorative accessory for wrapping a mailbox with a cover having a decorative shape. U.S. Pat. No. 11,242,708 discloses a door cover system for covering a door and displaying a decorative pattern on the door. U.S. Pat. Application No. 2001/0022056 discloses a decorative post covering comprising two L-shaped members which mate with each other around the post and which have a decorative surface facing outwardly from the post. U.S. Pat. Application No. 2013/0022781 discloses a wrap for wrapping a column and displaying indicia outwardly away from the column.

### BRIEF SUMMARY OF THE INVENTION

An embodiment of the disclosure meets the needs presented above by generally comprising a plank. A cover being removably positioned around and removably secured to the plank such that a front side of the cover faces outwardly away from the plank. The cover is flexible such that the cover conforms to a shape of the plank, and an indicia being positioned on the front side of the cover.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a sign apparatus according to an embodiment of the disclosure.

FIG. 2 is a back view of an embodiment of the disclosure.

FIG. 3 is a top back side perspective view of an embodiment of the disclosure.

FIG. 4 is a side view of an embodiment of the disclosure.

FIG. 5 is an exploded view of an embodiment of the disclosure.

FIG. 6 is a front view of an alternative embodiment of the disclosure.

FIG. 7 is a front view of an alternative embodiment of the disclosure.

FIG. 8 is a front view of an alternative embodiment of the disclosure.

### DETAILED DESCRIPTION OF THE INVENTION

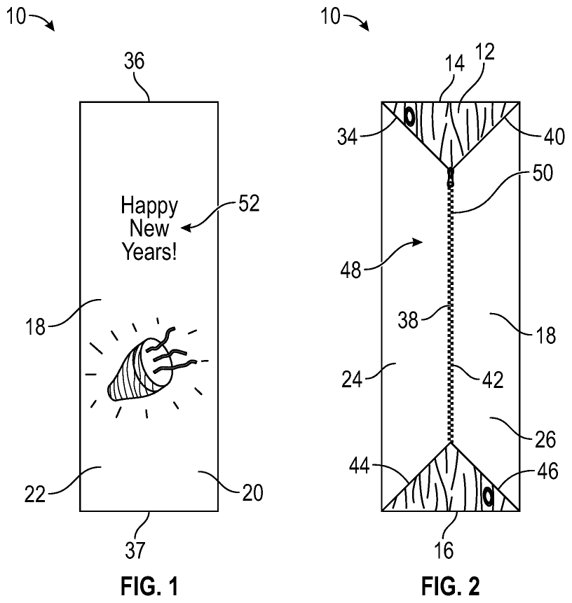

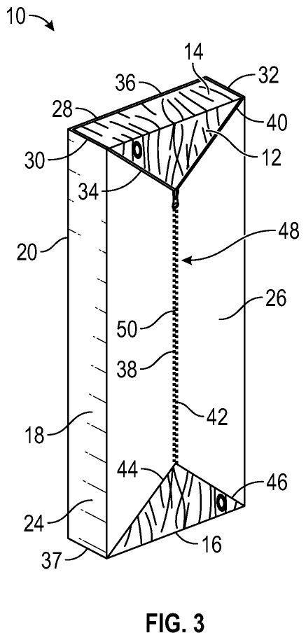

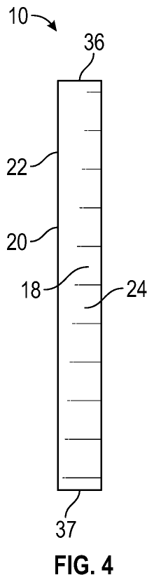

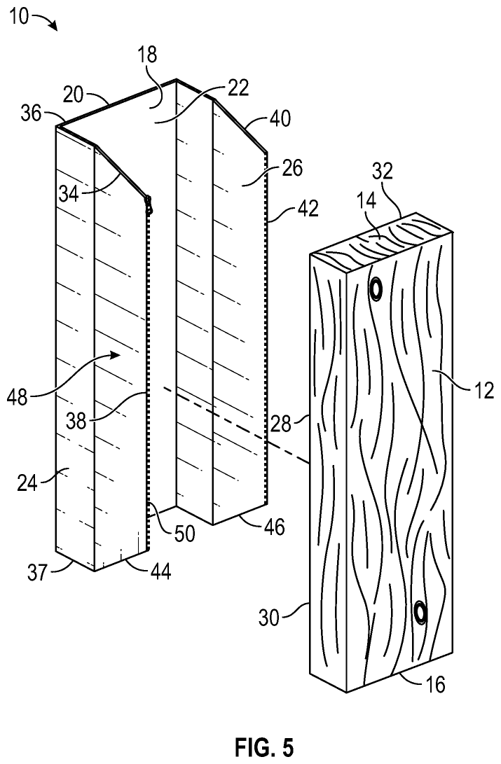

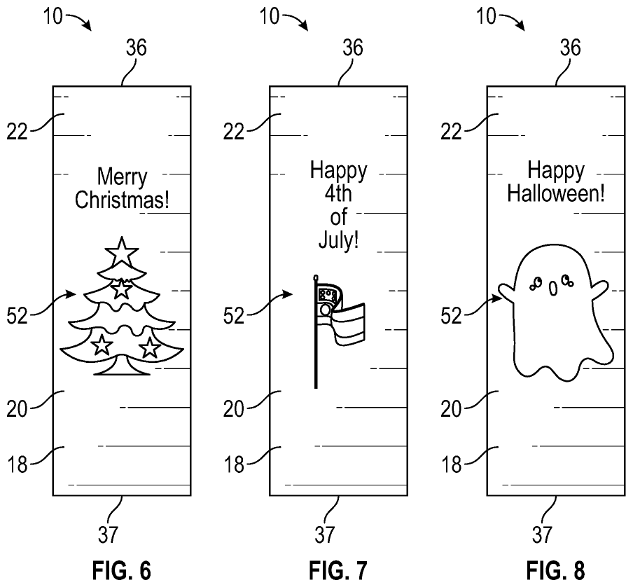

With reference now to the drawings, and in particular to FIGS. 1 through 8 thereof, a new sign apparatus embodying the principles and concepts of an embodiment of the disclosure and generally designated by the reference numeral 10 will be described.

As best illustrated in FIGS. 1 through 8, the sign apparatus 10 generally comprises a plank 12 which is elongated between a top end 14 and a bottom end 16 of the plank 12 and has a rectangular cross section taken along a horizontal plane. A cover 18 is removably positioned around and removably secured to the plank 12 such that a front side 20 of the cover 18 faces outwardly away from the plank 12. The cover 18 is flexible such that the cover 18 conforms to a shape of the plank 12. The cover 18 includes a central portion 22, a first lateral portion 24, and a second lateral portion 26. The central portion 22 extends between the first lateral portion 24 and the second lateral portion 26 and is positioned on a front surface 28 of the plank 12. The central portion 22 extends entirely across the front surface 28 of the plank 12. The front surface 28 is planar. Each of the first lateral portion 24 and the second lateral portion 26 extends rearwardly with respect to the central portion 22 and around each of a first lateral edge 30 and a second lateral edge 32 of the plank 12.

The first lateral portion 24 has an upper edge 34 which is angled downwardly from a top end 36 of the cover 18 to an outer edge 38 of the first lateral portion 24. The second lateral portion 26 has a top edge 40 which is angled downwardly from the top end 36 of the cover 18 to an outer edge 42 of the second lateral portion 26. The first lateral portion 24 has a lower edge 44 which is angled upwardly from a bottom end 37 of the cover 18 to the outer edge 38 of the first lateral portion 24. The second lateral portion 26 has a bottom edge 46 is angled upwardly from the bottom end 37 of the cover 18 to the outer edge 42 of the second lateral portion 26.

A closure 48 is attached to the first and second lateral portions 24, 26, and the closure 48 releasably couples the first lateral portion 24 to the second lateral portion 26 to retain the cover 18 on the plank 12. The cover 18 is resiliently stretchable and is sized such that the cover 18 is stretchable around the plank 12 to frictionally engage the plank 12. The closure 48 comprises a zipper 50 which is attached to the first and second lateral portions 24, 26, but the closure 48 may comprise a hook-and-loop fastener, a button, a snap, a tie, or the like.

An indicia 52 is positioned on the front side 20 of the cover 18. The term “indicia” in the specification and the claims is used to refer to both a singular marking and a plurality of markings. The indicia 52 may include alphanumeric characters, symbols, graphical images, colors, shapes, or the like. The indicia 52 may also include a welcome message, a holiday greeting, or the like. The plank 12 may also include separate indicia for display without the cover 18.

In use, the cover 18 is positioned around the plank 12, and the closure 48 is closed to releasably couple the first lateral portion 24 of the cover 18 to the second lateral portion 26 such that the cover 18 is retained on the plank 12. The plank 12 is then positioned to display the indicia 52. For example, the plank 12 may be placed on a porch outside a home or business. The plank 12 may also be attached, permanently or removably, to a structure via a hook, hanger, threaded fastener, hook-and-loop fastener, or like attachment means. The plank 12 may be integral to the structure. Multiple covers 18 with unique indicia 52 from each other may be interchangeably deployed onto the plank 12 such that the indicia 52 displayed may be changed as desired.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A sign apparatus comprising:
a plank;
a cover being removably positioned around and removably secured to the plank such that a front side of the cover faces outwardly away from the plank, the cover being flexible such that the cover conforms to a shape of the plank; and
an indicia being positioned on the front side of the cover.

2. The apparatus of claim 1, wherein the plank is elongated between a top end and a bottom end of the plank, the plank having a rectangular cross section taken along a horizontal plane.

3. The apparatus of claim 1, wherein the cover includes a central portion, a first lateral portion, and a second lateral portion, the central portion extending between the first lateral portion and the second lateral portion, the central portion being positioned on a front surface of the plank, each of the first lateral portion and the second lateral portion extending rearwardly with respect to the central portion and around each of a first lateral edge and a second lateral edge of the plank.

4. The apparatus of claim 3, wherein the central portion extends entirely across the front surface.

5. The apparatus of claim 3, wherein the front surface is planar.

6. The apparatus of claim 1, wherein the first lateral portion has an upper edge being angled downwardly from a top end of the cover to an outer edge of the first lateral portion, the second lateral portion having a top edge being angled downwardly from the top end of the cover to an outer edge of the second lateral portion, the first lateral portion having a lower edge being angled upwardly from a bottom end of the cover to the outer edge of the first lateral portion, the second lateral portion having a bottom edge being angled upwardly from the bottom end of the cover to the outer edge of the second lateral portion.

7. The apparatus of claim 3, further comprising a closure being attached to the first and second lateral portions and releasably coupling the first lateral portion to the second lateral portion to retain the cover on the plank.

8. The apparatus of claim 7, wherein the cover is resiliently stretchable, the cover being sized such that the cover is stretchable around the plank to frictionally engage the plank.

9. The apparatus of claim 7, wherein the closure comprises a zipper being attached to the first and second lateral portions.

10. A sign apparatus comprising:
a plank, the plank being elongated between a top end and a bottom end of the plank, the plank having a rectangular cross section taken along a horizontal plane;
a cover being removably positioned around and removably secured to the plank such that a front side of the cover faces outwardly away from the plank, the cover being flexible such that the cover conforms to a shape of the plank, the cover including a central portion, a first lateral portion, and a second lateral portion, the central portion extending between the first lateral portion and the second lateral portion, the central portion being positioned on a front surface of the plank, the central portion extending entirely across the front surface of the plank, the front surface being planar, each of the first lateral portion and the second lateral portion extending rearwardly with respect to the central portion and around each of a first lateral edge and a second lateral edge of the plank, the first lateral portion having an upper edge being angled downwardly from a top end of the cover to an outer edge of the first lateral portion, the second lateral portion having a top edge being angled downwardly from the top end of the cover to an outer edge of the second lateral portion, the first lateral portion having a lower edge being angled upwardly from a bottom end of the cover to the outer edge of the first lateral portion, the second lateral portion having a bottom edge being angled upwardly from the bottom end of the cover to the outer edge of the second lateral portion;
a closure being attached to the first and second lateral portions and releasably coupling the first lateral portion to the second lateral portion to retain the cover on the plank, the cover being resiliently stretchable, the cover being sized such that the cover is stretchable around the plank to frictionally engage the plank, the closure comprising a zipper being attached to the first and second lateral portions; and
an indicia being positioned on the front side of the cover.
